(19) United States
(12) Patent Application Publication
(10) Pub. No.: US 2005/0025479 A1
(43) Pub. Date: Feb. 3, 2005

(54) Digital camera

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/900,142

(22) Filed: Jul. 28, 2004

(30) Foreign Application Priority Data
Jul. 29, 2003 (JP) 2003-281568

(51) Int. Cl. G03B 17/02

(52) U.S. Cl. 396/535

(57) ABSTRACT

A digital camera includes an image sensor unit which is fixed to a camera body, the image sensor unit incorporating an image sensor package including an image sensor, and a reference plate which serves as a positional reference when fixed to the camera body, the image sensor package being mounted to the reference plate. An internal member of the camera body to which the reference plate is fixed is made of a material which is higher in strength and has a lower specific heat capacity than aluminum and resin. The reference plate is made of a material which is greater in strength than aluminum and resin, a surface of the reference plate including a coating having a higher degree of thermal conductivity than aluminum so that heat produced by the image sensor package is transferred to the internal member via the coating.

### BACKGROUND OF THE INVENTION

1. Field of the Invention

The present invention relates to a digital camera having an image pick-up device such as a CCD image sensor, and more specifically relates to such a digital camera having a structure for preventing the quality of the image captured by the image pick-up device from being degraded by the heat produced by the image pick-up device.

2. Description of the Related Art

A CCD image sensor is widely used as an image pick-up device (image sensor) of a digital camera. This type of CCD image sensor is usually provided in the form of a CCD package (image sensor package), and this CCD package is included in a camera body, mounted thereto. The CCD package is constructed so that a CCD chip (CCD image sensor) is fixed to a package base by adhesive or solder and so that the CCD chip is electrically connected to external leads provided on the package base. A protection glass plate is fixed to the front of the package base to seal the CCD chip between the protection glass plate and the package base. When the CCD package is fixed to the camera body to be supported thereby, a rear surface of the package base of the CCD package is bonded closely to a front surface (fixing surface) of a reference plate which serves as a positional reference for the fixing position of the CCD chip when fixed to the camera body. The CCD package which is structured in such a manner is installed at a position (image forming position) inside the camera body in the vicinity of the rear surface thereof where an image is formed through a photographing optical system. Specifically, a light receiving surface (imaging surface) of the CCD chip is oriented to be orthogonal to the optical axis of the photographing optical system at a position of an image plane, on which an image is formed through a photographing optical system, usually at a focal point of the photographing optical system.

In such a conventional digital camera using a CCD image sensor as an image pick-up device, the temperature of the CCD chip rises excessively due to the driving current supplied thereto if the CCD chip continues to operate for a long period of time. This temperature rise increases the dark current in the CCD chip, thus causing an increase in noise of the image captured by the CCD chip. Therefore, the digital camera is required to have a heat-dissipation structure (radiating structure) which rapidly dissipates the heat produced by the CCD chip. In a CCD unit of a conventional digital camera, the reference plate of the CCD unit is fixed directly to a camera body to be supported thereby so that the heat produced by the CCD chip is transferred from the package base to the reference plate to be dissipated from the reference plate. For instance, a technology for making the reference plate of a CCD unit that incorporates a CCD package contact with a camera body and for fixing the reference plate to the camera body by set screws has been proposed in Japanese Unexamined Patent Publication No. 2003-69886.

In such a heat-dissipation structure as described above, which is designed in consideration of heat-dissipation efficiency, although heat is transferred from the CCD package to the reference plate, if the reference plate is formed as a small plate made of a material having a high degree of thermal conductivity such as aluminum, the heat transferred from the CCD package is rapidly transferred over the entire reference plate to thereby cause the reference plate to reach a thermal equilibrium state in a short period of time, which causes a reduction in the heat-dissipation efficiency from that point onwards. Specifically, if the reference plate is thin, the reference plate is apt to be deformed by heat. This deformation causes the position of the imaging surface of the CCD chip to deviate from the original position, thus causing the object image formed thereon to become out-of-focus. On the other hand, it is sometimes the case that the reference plate is formed thick to increase its heat capacity and to resist being deformed by heat, or that the reference plate is provided with a reinforcing rib or ribs to increase the mechanical strength of the reference plate. However, this increases the thickness of the digital camera in the optical axis direction of the photographing lens, being detriment to miniaturization of the digital camera.

### SUMMARY OF THE INVENTION

The present invention provides a digital camera in which the heat produced by the image pick-up device is rapidly dissipated to improve the quality of imaging and which has a structure making miniaturization of the digital camera possible. According to the present invention, a digital camera is provided, including an image sensor unit which is fixed to a camera body, the image sensor unit incorporating an image sensor package including an image sensor; a reference plate which serves as a positional reference when fixed to the camera body, the image sensor package being mounted to the reference plate; and an internal member provided in the camera body, wherein the reference plate is fixed to the internal member. The internal member is made of a material which is higher in strength and has a lower specific heat capacity than aluminum and resin. The reference plate is made of a material which is greater in strength than aluminum and resin, a surface of the reference plate including a coating having a higher degree of thermal conductivity than aluminum so that heat produced by the image sensor package is transferred to the internal member via the coating.

It is desirable for the tension strength of the material of the internal member to be equal to or greater than 618 MPa, for the specific heat capacity of the material of the internal member to be equal to or less than 0.435 j/g·K, for the tension strength of the material of the reference plate to be equal to or greater than 618 MPa, and for the thermal conductivity of the coating to be equal to or greater than 83.5 W/m·K.

It is desirable for the internal member to be made of a ferrous metal, copper or a copper-based alloy.

It is desirable for the copper-based alloy to be brass.

It is desirable for the reference plate to be made of a ferrous metal.

It is desirable for the ferrous metal to be stainless steel.

It is desirable for a material of the coating to be copper.

It is desirable for a surface of the internal member to which the reference plate is fixed to have a copper coating.

It is desirable for the internal member to include at least one support boss to which the reference plate is fixed to be supported thereby, the support boss being made of copper or a copper-based alloy.

It is desirable for the copper-based alloy to be brass.

It is desirable for the image sensor package to be bonded to the reference plate by an adhesive having a high degree of thermal conductivity.

It is desirable for the internal member to include a frame having a rectangular aperture, through which a light bundle of an object that is passed through a photographing lens attached to the camera body is incident on an imaging surface of the image sensor. The support boss projects from the frame so that the reference frame is fixed to an end surface of the support boss.

It is desirable for substantially the entire surface of the reference plate to be coated with the coating.

In another embodiment, a digital camera is provided, including an image sensor unit which is fixed to a camera body, the image sensor unit incorporating an image sensor package including an image sensor, and a reference plate which serves as a positional reference when fixed to the camera body, the image sensor package being mounted to the reference plate. An internal member of the camera body to which the reference plate is fixed is made of a material having a tension strength which is one of equal to and greater than 618 MPa and a specific heat capacity which is one of equal to and smaller than 0.435 j/g·K. The reference plate is made of a material having a tension strength which is one of equal to and greater than 618 MPa. A surface of the reference plate includes a coating having a thermal conductivity which is one of equal to and greater than 83.5 W/m·K.

The present disclosure relates to subject matter contained in Japanese Patent Application No. 2003-281568 (filed on Jul. 29, 2003) which is expressly incorporated herein by reference in its entirety.

### BRIEF DESCRIPTION OF THE DRAWINGS

The invention will be discussed below in detail with reference to the accompanying drawings, in which:

FIG. 1 is a perspective view, with a portion broken away for clarity, of a first embodiment of a digital camera according to the present invention, viewed obliquely from behind the digital camera;

FIG. 2 is an exploded perspective view of elements of the digital camera shown in FIG. 1;

FIG. 3 is an enlarged cross sectional view taken along the III-III line in FIG. 1;

FIG. 4 is a perspective view of a CCD unit, viewed obliquely from the front thereof;

FIG. 5 is an exploded perspective view of the CCD unit shown in FIG. 4; and

FIG. 6 is a cross sectional view of a portion of a second embodiment of the digital camera according to the present invention.

### DESCRIPTION OF THE PREFERRED EMBODIMENTS

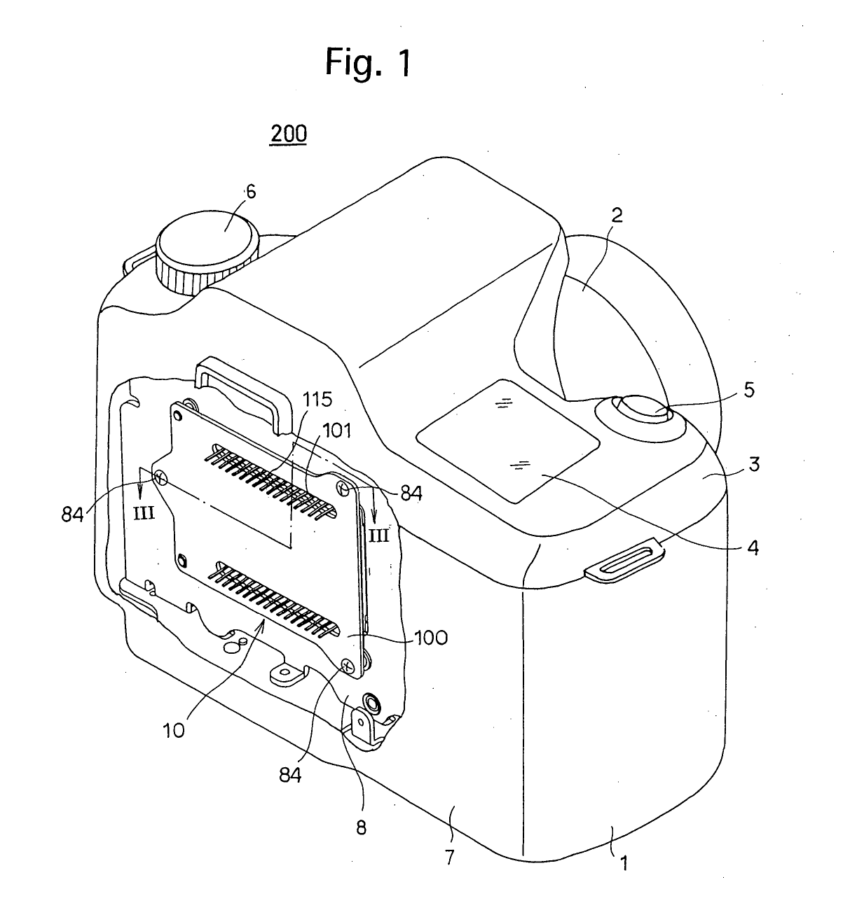

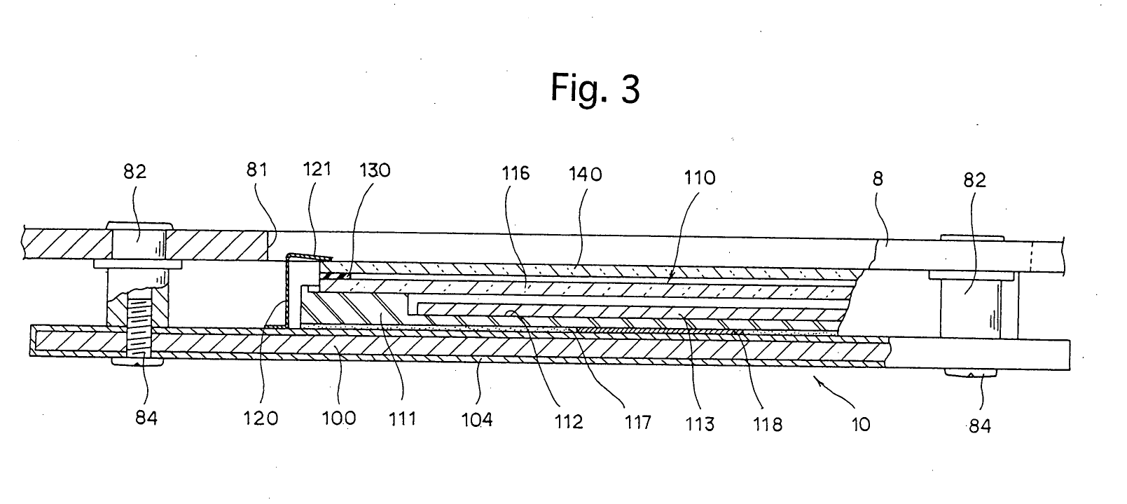

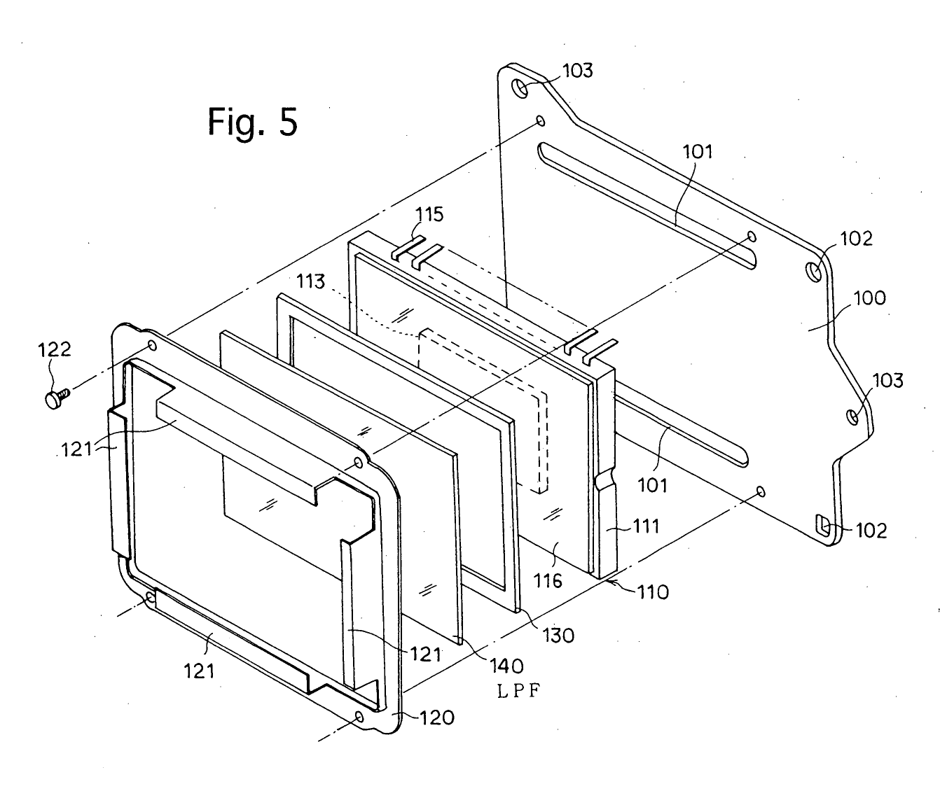

FIG. 1 shows a first embodiment of a digital camera according to the present invention. The digital camera 200 that is constructed as an SLR digital camera is provided with an interchangeable photographing lens 2 which is detachably attached to the front of a camera body 1. The digital camera 200 is provided on a top cover 3 of the camera body 1 with an LCD indicating portion 4, a release button 5 and a select dial (dial switch) 6. The digital camera 200 is provided on a back cover 7, a portion of which is broken away for clarity in FIG. 1, with an LCD monitor and various switches (all of which are not shown in FIG. 1). The digital camera 200 is provided therein inside the back cover 7 (i.e., inside the camera body 1) with an image sensor unit 10. This image sensor unit 10 will be hereinafter referred to as a CCD unit 10 since the digital camera 200 uses a CCD image sensor as an image pick-up device. The CCD unit 10 is fixed to a main frame 8 (an internal structure (internal member) of the camera body 1) positioned inside the camera body 1 in an internal space thereof behind a mirror box (not shown) provided in the camera body 1 so that an imaging surface of a CCD chip 113 (see FIGS. 3 and 5) lies in a focal plane on which an object image is formed through the photographing lens 2.

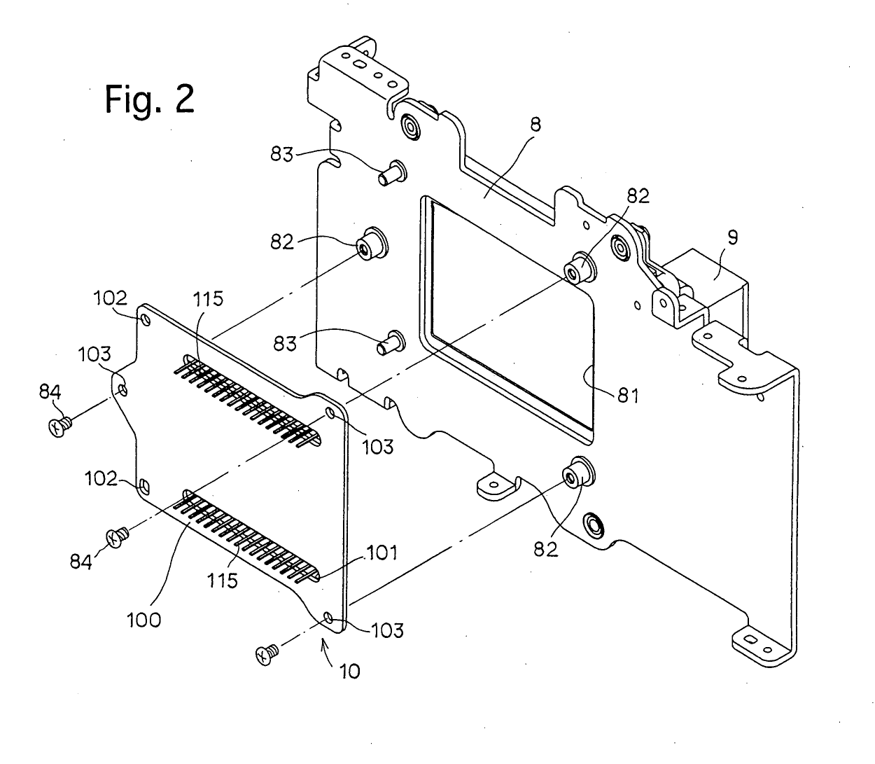

FIG. 2 is an exploded perspective view of elements of the digital camera 200, and FIG. 3 is an enlarged cross sectional view taken along III-III line in FIG. 1. As shown in FIG. 2, the digital camera 200 is provided in front of the main frame 8 with a shutter unit 9, and is provided, in front of the mirror box (not shown) that accommodates the shutter unit 9, with a lens mount ring (not shown) to which the photographing lens 2 is detachably attached. The lens mount is fixed to a front surface of the camera body 1 to be supported thereby. The main frame 8 is made of a ferrous metal which has a higher strength than an aluminum alloy (aluminum die-casting alloys) or fiber-reinforced plastics which are used as materials for conventional reference plates, and which has a lower specific heat capacity than an aluminum alloy or fiber-reinforced plastics. More specifically, the main frame 8 is made out of a stainless steel plate in the first embodiment of the digital camera 200; namely, the stainless steel plate is shaped into a predetermined shape of the main frame 8, and is provided with a rectangular aperture 81 through which the CCD unit 10 is communicatively connected with the mirror box so that a bundle of light of an object image which is formed through the photographing lens 2 passes through the rectangular aperture 81 to be focused on the imaging surface of the CCD unit 10. Accordingly, the CCD unit 10 is fixed to the main frame 8 at a position facing the rectangular aperture 81.

The main frame 8 is provided on a rear surface thereof around the rectangular aperture 81 with three cylindrical support bosses 82, each of which is fixed integral with the main frame 8 by swaging. Each cylindrical support boss 82 is made of copper or a copper-based alloy (e.g., brass) which has a higher thermal conductivity than ferrous metals. A reference plate (base plate) 100 provided as an element of the CCD unit 10 is positioned to be in contact with end surfaces of the three cylindrical support bosses 82 so that three set screws 84 for fixing the CCD unit 10 to the main frame 8 can be screwed into the three cylindrical support bosses 82, respectively. Two narrow cylindrical positioning pins 83 project rearward from a rear surface of the main frame 8 at upper and lower positions thereon in the vicinity of upper and lower ends of a side edge (left side edge as viewed in FIG. 2) of the rectangular aperture 81, respectively. Each positioning pin 83 is integrally fixed to the main frame by swaging. The positioning pins 83 are respectively engaged in two positioning holes 102 of the CCD unit 10 to position the CCD unit 10 precisely with respect to the main frame 8. Although not limited solely to a particular material, the material of each positioning pin 83 is desirably made of copper or a copper-based alloy (e.g., brass) likewise with each cylindrical support boss 82 because the heat produced by the CCD chip 113 when the CCD chip 113 operates may be partly transferred to the main frame 8 via the two positioning pins 83.

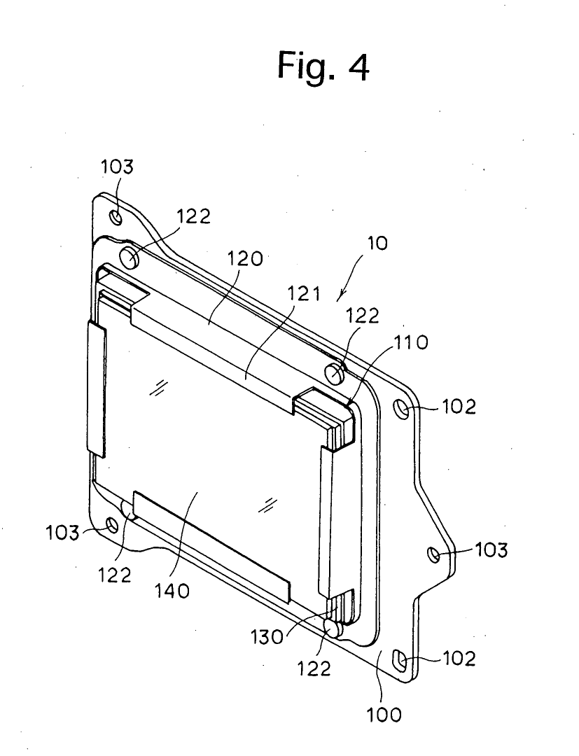

As shown in the perspective view and the exploded perspective view in FIGS. 4 and 5, respectively, the CCD unit 10 is provided with a holding frame (holding member) 120 provided as a separate member from the reference plate 100, and is further provided with a CCD package (image sensor package) 110 which is mounted to the reference plate 100 via the holding frame 120. The CCD package 110 is supplied as a package produced in a factory. As can be seen in FIG. 3, the CCD package 110 is provided with a package base 111 made of a material such as ceramics or resin. The package base 111 is provided on a surface thereof with a mounting recess 112 in which the CCD chip 113 is positioned. The CCD chip 113 is mounted and bonded to a bottom surface of the mounting recess 112 by a bonding agent (not shown) such as an adhesive or a low-melting solder. Electrodes of the CCD chip 113 are electrically connected to two external lead arrays 115 which extend from the package base 111 via an internal wiring system (not shown). The CCD chip 113 is sealed with a projection grass 116 which is bonded to a front surface of the package base 111.

On the other hand, the reference plate 100 is made of a ferrous metal having higher strength than either aluminum alloys (aluminum die-casting alloys) or fiber-reinforced plastics which are used as materials for conventional reference plates. More specifically, the reference plate 100 is made of a stainless steel plate in the first embodiment of the digital camera 200; namely, the stainless steel plate is shaped into a predetermined shape of the reference plate 100. As shown in FIG. 3, the entire surface of the reference plate 100 is coated with a plating (a copper plating or a copper-based alloy plating) that has a higher thermal conductivity than aluminum. Specifically, the entire surface of the reference plate 100 is coated with a copper plating (copper coating) 104 in the first embodiment of the digital camera. The reference plate 100 is provided with two slots 101 in which the two external lead arrays 115 of the CCD package 110 are insertable, respectively. A rear surface of the CCD package 110 is bonded to a front surface (mounting surface) of the reference plate 100 by an adhesive 117 with the two external lead arrays 115 being inserted in the two slots 101, respectively. An instantaneous adhesive that solidifies in an extremely short period of time is used as the adhesive 117 in the first embodiment of the digital camera 200. However, another type of adhesive which solidifies in a relatively long period of time can be used instead. The reference plate 100 is provided, on a surface thereof other than the surface to which the CCD package 110 is bonded, with the two positioning holes 102 which are formed to correspond to the positions of the two positioning pins 83, respectively, that project from the main frame 8. The reference plate 100 is further provided, at three positions thereon corresponding to the positions of the three support bosses 82, with three fixing holes 103, respectively.

The specific heat of aluminum is 0.880 (j/g·K), and the specific heat of a stainless steel is 0.435 (j/g·K). The thermal conductivities of aluminum, a stainless steel and copper are 236, 83.5 and 403 (W/m·K), respectively. The tension strengths of aluminum, plastics (synthetic resins) and a stainless steel are 166-566 (MPa), 40-200 (MPa) and 618-1059 (MPa), respectively.

The holding frame 120 is fixed to a front surface of the reference plate 100 that is constructed in the above described manner. The holding frame 120 is fixed to the reference plate 100 by four set screws. 122 (only one of them is shown in FIG. 5) which extend through the holding frame 120 at four different points on the periphery of the holding frame 120. The holding frame 120 is made of a resilient metal plate which is shaped into a rectangular frame. The holding frame 120 is provided on four sides thereof with four holding leaves 121, each of which is formed by bending a portion of the holding frame 120. In addition, the first embodiment of the CCD package 110 is provided on a front surface of the protection glass 116 with a dust-resistant sealing member 130 having a rectangular frame shape, and is provided on the dust-resistant sealing member 130 with a rectangular low-pass filter (LPF) 140 having dimensions substantially identical to the dimensions of the protection glass 116. The resiliency of the four holding leaves 121 of the holding frame 120 causes the low-pass filter 140 to be pressed against a front surface of the protection glass 116 via the dust-resistant sealing member 130, and simultaneously presses the low-pass filter 140 and the dust-resistant sealing member 130, together with the CCD package 110, against the reference plate 100 to hold the low-pass filter 140, the dust-resistant sealing member 130 and the CCD package 110 to the reference plate 100.

When the CCD unit 10 that has the above described structure is assembled, firstly the CCD package 110 is bonded to the reference plate 100 by the adhesive 117. Subsequently, the dust-resistant sealing member 130 and the low-pass filter 140 are placed on the protection glass 116 in that order, and subsequently, the holding frame 120 is placed on the reference plate 100 from above the low-pass filter 140, and is fixed to the reference plate 100 by four set screws 122, thus completing the assembling operation for assembling the CCD unit 10.

Subsequently, the CCD unit 10 is fixed to the main frame 8. In this CCD unit fixing process, the position of the CCD unit 10 on a rear flat surface of the main frame 8 is determined by fitting each of the two positioning holes 102 on the associated positioning pin 83 of the main frame 8. Thereafter, the reference plate 100 is fixed to the main frame 8 by screwing the three set screws 84 into the three cylindrical support bosses 82, respectively, with the end surface of each support boss 82 being in contact with the front surface of the reference plate 100 to thereby fix the CCD unit 10 to the main frame 8.

In the digital camera 200 in which the CCD unit 10 is fixed to the main frame 8 in the above described manner, the heat that is produced by the CCD chip 113, when the CCD chip 113 operates, is transferred to the reference plate 100 via the package base 110 of the CCD package 110. The heat transmitted to the reference plate 100 is transmitted to the copper plating 104 so as to travel along the surface of the reference plate 100 while being dispersed, and is subsequently transferred to the main frame 8 via the three support bosses 82, which are made of copper or a copper-based alloy (e.g., brass) that has high thermal conductivity. At this time, some of the heat produced by the CCD chip 113 may be transferred to the copper plating 104 via the two positioning pins 83. The heat transmitted to the main frame 8 from the reference plate 100 is gradually dispersed to the peripheral of the main frame 8, which is made of a ferrous metal which has a lower specific heat capacity than aluminum, to be dissipated from the surface of the main frame 8, the surface area of which is relatively large. At this time, a thermal gradient occurring across the main frame 8 from the swaged portion of each support boss 82 to the periphery of the main frame 8 is secured so that the heat produced by the CCD chip 113 continues to be transferred from the reference plate 100 to the main frame 8. Accordingly, the heat-dissipation efficiency of the CCD chip 113 can be maintained for a long period of time.

Namely, the heat transferred from the CCD chip 113 to the reference plate 100 does not remain in the reference plate 100 to thereby increase the heat-dissipation efficiency of the CCD chip 113 since the heat produced by the CCD chip 113 is rapidly transferred to the main frame 8 via the copper plating 104 and the support bosses 82, which prevent the temperature of the CCD chip 113 from rising excessively, thus making it possible to effectively reduce noise of the image captured by the CCD chip 113. On the other hand, since the strength of the reference plate 100 is high, the reference plate 100 does not have to be formed thick or provided with any ribs to be prevented from being deformed; moreover, miniaturization of the digital camera 200 is achieved since the general thickness of the reference plate 100 can be decreased to reduce the length of the digital camera 200 in the optical axis direction of the photographing lens.

In addition, since the main frame 8, which is an internal structure (internal element) of the camera body 1, is made of a ferrous metal such as a stainless steel and is shaped via press forming, the production cost of making a mold for casting the camera body 1 that includes the main frame 8 can be reduced by a larger amount than the case where the camera body 1 is made as an aluminum die-casting or a molded synthetic product made of, e.g., fiber-reinforced plastic; moreover, the material cost is also low, and therefore advantageous for reducing the production cost of the digital camera 200. It should be noted that the main frame 8 can be made of copper or a copper-based alloy (e.g., brass) if it has higher strength than either aluminum or plastics (synthetic resins) and smaller thermal conductivity than either aluminum or plastics (synthetic resins).

[Second Embodiment]

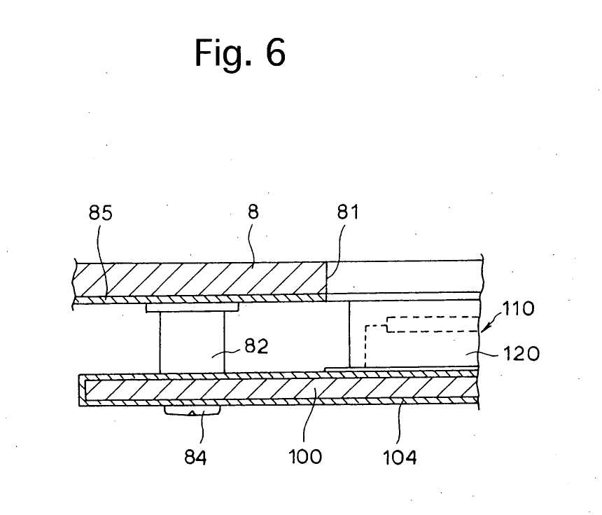

FIG. 6 is a cross sectional view of a portion of a second embodiment of the digital camera according to the present invention, which corresponds to a portion of the cross sectional view shown in FIG. 3. The second embodiment of the digital camera shown in FIG. 6 is identical to the first embodiment of the digital camera except that a rear surface (bottom surface as viewed in FIG. 6) of the main frame 8 to which the three cylindrical support bosses 82 are fixed by swaging is further coated with a plating (a copper plating or a copper-based alloy plating) that has a higher thermal conductivity than aluminum. Specifically, the aforementioned rear surface of the stainless main frame 8 is coated with a copper plating (copper coating) 85 in the second embodiment of the digital camera. With the copper plating 85 formed on the main frame in such a manner, the heat which is produced by the CCD chip 113 and transferred from the copper plating 104 to the support bosses 82 is rapidly transferred from the three support bosses 82 to a wide area of the main frame 8 via the copper plating 85, and subsequently, the heat travels through the main frame 8 in a direction of the thickness thereof (vertical direction as viewed in FIG. 6) via the entire area of the copper plating 85. This makes it possible to obtain an improvement in continuous heat-dissipation efficiency by a thermal gradient which occurs across the main frame 8. The CCD chip 113 can be cooled with a higher degree of efficiency in the second embodiment of the digital camera than in the first embodiment of the digital camera because the surface of the main frame 8, which has a larger surface area than the reference plate 100, can be fully used as a heat radiator for cooling the CCD chip 113.

If an adhesive having a high degree of thermal conductivity is used as the adhesive 117, the heat produced by the CCD chip 113 can be transferred more easily from the package base 111 to the reference plate 100 via the adhesive 117, which further improves the heat-dissipation efficiency of the CCD chip 113. In the case where it is difficult to adopt an adhesive having a high degree of thermal conductivity, a heat dissipation grease 118 having a high degree of thermal conductivity can be applied to a portion of the rear surface of the package base 111 of the CCD package 110 as shown in FIG. 3 (specifically on an area of the package base 111 immediately behind the CCD chip 113), or a radiating sheet can be installed between the rear surface of the package base 111 and the reference plate 100. In this case using the heat dissipation grease 118 or the radiating sheet, the heat produced by the CCD chip 113 can be ideally transferred to the copper plating 104 of the reference plate 100.

The image pick-up device incorporated in a digital camera according to the present invention is not limited solely to a CCD image sensor. Specifically, the present invention can be applied to any type of image pick-up device in which the quality of the image captured by the image pick-up device is degraded by heat produced by the image pick-up device.

According to the above description, it is possible for heat produced by the image sensor (image pick-up device) to be transferred to the camera body via a coating having a high thermal conductivity and for the heat-dissipation efficiency of the image sensor to be maintained by a thermal gradient occurring across a relatively small camera body, and accordingly, the heat-dissipation efficiency can be increased. Moreover, if the reference plate is made of a material having high strength, the reference plate can be prevented from being deformed by an external force, and also can be formed thin, which is advantageous to miniaturization of the digital camera.

Obvious changes may be made in the specific embodiments of the present invention described herein, such modifications being within the spirit and scope of the invention claimed. It is indicated that all matter contained herein is illustrative and does not limit the scope of the present invention.

1. A digital camera comprising:
an image sensor unit which is fixed to a camera body, said image sensor unit incorporating an image sensor package including an image sensor;
a reference plate which serves as a positional reference when fixed to said camera body, said image sensor package being mounted to said reference plate; and
an internal member provided in said camera body, wherein said reference plate is fixed to said internal member;
wherein at least said internal member is made of a material which is higher in strength and has a lower specific heat capacity than aluminum and resin, and
wherein said reference plate is made of a material which is greater in strength than aluminum and resin, a surface of said reference plate including a coating having a higher degree of thermal conductivity than aluminum so that heat produced by said image sensor package is transferred to said internal member via said coating.

2. The digital camera according to claim 1, wherein the tension strength of said material of said internal member is one of equal to and greater than 618 MPa,
wherein the specific heat capacity of said material of said internal member is one of equal to and less than 0.435 j/g·K,
wherein the tension strength of said material of said reference plate is one of equal to and greater than 618 MPa, and
wherein the thermal conductivity of said coating is one of equal to and greater than 83.5 W/m·K.

3. The digital camera according to claim 1, wherein said internal member is made of one of a ferrous metal, copper and a copper-based alloy.

4. The digital camera according to claim 3, wherein said copper-based alloy comprises brass.

5. The digital camera according to claim 1, wherein said reference plate is made of a ferrous metal.

6. The digital camera according to claim 5, wherein said ferrous metal comprises stainless steel.

7. The digital camera according to claim 1, wherein a material of said coating comprises copper.

8. The digital camera according to claim 1, wherein a surface of said internal member to which said reference plate is fixed comprises a copper coating.

9. The digital camera according to claim 1, wherein said internal member comprises at least one support boss to which said reference plate is fixed to be supported thereby, said support boss being made of one of copper and a copper-based alloy.

10. The digital camera according to claim 9, wherein said copper-based alloy comprises brass.

11. The digital camera according to claim 1, wherein said image sensor package is bonded to said reference plate by an adhesive having a high degree of thermal conductivity.

12. The digital camera according to claim 9, wherein said internal member comprises a frame having a rectangular aperture, through which a light bundle of an object that is passed through a photographing lens attached to said camera body is incident on an imaging surface of said image sensor, and
wherein said support boss projects from said frame so that said reference frame is fixed to an end surface of said support boss.

13. The digital camera according to claim 1, wherein a substantially entire surface of said reference plate is coated with said coating.

14. A digital camera comprising:
an image sensor unit which is fixed to a camera body, said image sensor unit incorporating an image sensor package including an image sensor, and a reference plate which serves as a positional reference when fixed to said camera body, said image sensor package being mounted to said reference plate,
wherein an internal member of said camera body to which said reference plate is fixed is made of a material having a tension strength which is one of equal to and greater than 618 MPa and a specific heat capacity which is one of equal to and smaller than 0.435 j/g·K,
wherein said reference plate is made of a material having a tension strength which is one of equal to and greater than 618 MPa, and
wherein a surface of said reference plate comprises a coating having a thermal conductivity which is one of equal to and greater than 83.5 W/m·K.
